(19) United States
(12) Patent Application Publication
(10) Pub. No.: US 2009/0013755 A1
(43) Pub. Date: Jan. 15, 2009

(54) Calibration jig and algorithms for accelerometer

(75) Inventors: Ming-Zuan Tsai, Zhubei City (TW); Shang-Ming Wang, Zhubei City (TW)

Correspondence Address: BIRCH STEWART KOLASCH & BIRCH, PO BOX 747, FALLS CHURCH, VA, 22040-0747, US

(73) Assignee: Polstar Technologies Inc.

(21) Appl. No.: 11/822,835

(22) Filed: Jul. 10, 2007

(51) Int. Cl. G01P 21/00

(52) U.S. Cl. 73/1.38

(57) ABSTRACT

The present invention provides a calibration system for accelerometer and the method of using the same. The calibration system includes a hexahedral calibration jig placed on a calibrated platform and a calibration module. The calibration jig includes at least four planes that are arranged in parallel or vertical with each other. The calibration module may be performing three algorithms for calibrating an accelerometer and calculating parameters for coordinate transfer.

### BACKGROUND OF THE INVENTION

1. Field of the Invention

The present invention relates to an accelerometer, and in particularly to a calibration jig and algorithms for calibrating an accelerometer.

2. Description of the Prior Art

Accelerometer is a mechanical or an electronic sensing device, typically used in detecting both static acceleration (gravity or G-value) and dynamic acceleration (centrifugal or linear acceleration).

As results of the technology development, accelerometer especially, MEMS accelerometer is now in widespread use recently. There are so many advantages associated with MEMS Accelerometer compared with traditional accelerometer. For instance, package is getting smaller, cost is affordable and system is easily integrated into variety of applications.

MEMS Accelerometer has been commercialized into consumer products successfully since last decade in addition to been used in aerospace engineering and military equipment (Inertial Navigation System in airplanes or missiles). Car alarm, Air bag and HDD protector in Notebook are typical applications of MEMS accelerometer. Those applications are only required accelerometer to detect a certain amount (over or under threshold) of acceleration in order to triggering other functions. However, measurement of precise acceleration on each axis of accelerometer is mandatory for some application of MEMS products. An Inclinometer with +/−0.1 degree resolution is a typical example.

There are three critical issues related to precise measurement of MEMS accelerometer. First of all is impact of temperature drift on almost all type of electronic devices, especially on analog sensors. We already have had solutions in facing this challenge and will be filed for patent protection later on. Second issue is how to calibrate zero g bias and 1g sensitivity on each axis of accelerometer. Third issue is how to calculate 9 direction cosines between three axes of accelerometer and three axes of target coordinate as parameters for coordinate transfer. This application is focused on algorithms of calibrating 0g, 1g on each axis of accelerometer and algorithm of calculating 9 direction cosines for coordinate transfer between two coordinates if required.

With calibration algorithms and jig stated in this application, it is convinced that a precise measurement of MEMS accelerometer is realistic and longer be a nightmare for end users or makers of consumer products who are going to integrate MEMS accelerometers into their products.

### SUMMARY OF THE INVENTION

Purpose of this invention is to calibrate any accelerometer in terms of calculating zero g bias and 1g sensitivity associated with each axis of accelerometer. This invention also provides an algorithm for calculating 9 direction cosines as parameters of coordinate transfer from three axes of an accelerometer to target coordinate if required.

The present invention comprises the followings as below:
1. A calibration system includes Calibration Jig and three Algorithms
2. Calibration Jig
3. Algorithm for calibrating zero g bias
4. Algorithm for calibrating 1g sensitivity
5. Algorithm for calculating 9 direction cosines between three axes of an accelerometer and orthogonal axes of target coordinate

### Theory of Operation:

Since accelerometer can sense either static acceleration (gravity or g value equals 9.8 m/sec²) or dynamic acceleration (both linear and rotational acceleration on moving device). There is no dynamic acceleration if a device is at constant velocity or in still (zero velocity). The only acceleration detected by accelerometer in still or moving at constant velocity is gravity (or g value). Gravity components over three orthogonal axes of accelerometer are defined in following equations.

Vector G=vector X_{g}+vector Y_{g}+vector Z_{g} Equation (1)

√(X²_{g}+Y²_{g}+Z²_{g}=1g Equation (2)

### Calibration System—(1):

A system includes a Calibration Jig (A hexahedron jig), a leveled platform and three Algorithms for calibrating 0g, 1g of accelerometer and calculating 9 direction cosines as parameters for coordinate transfer.

### Calibration Jig—(2):

A hexahedron jig at least four planes are arranged in parallel and vertical configuration with each other as a reference of horizontal or vertical. An Accelerometer to be calibrated is attached inside this jig. Since 9 direction cosines between axes of accelerometer and axes of hexahedron jig are fixed. Hexahedron jig is placed on a calibration platform (already leveled) with 4 different sides downwardly in sequence during calibration procedure.

Algorithm for Calibrating Zero g Bias (0g)—(3):

Zero g bias on each axis of accelerometer in calibration mode can be measured and calculated by placing hexahedron jig on Platform with following sequence.
Measure voltage output on each axis of accelerometer with any face (Said Z axis is pointed upward) of hexahedron jig pointed up.
   x_, y_, z_are output voltages of accelerometer
Measure voltage output on each axis of accelerometer with the same face (Z axis is pointed downward) of hexahedron jig pointed down.
   x, y, z are output voltages of accelerometer.
Zero g on each axis is calculated by taking average of output voltage on each axis measured at two procedures stated above.

X0=(x_{—}+x)/2 Equation (3)

Y0=(y_{—}+y)/2 Equation (4)

Z0=(z_{—}+z)/2 Equation (5)

Algorithm for Calibrating 1g Sensitivity (1g)—(4):

From Equation (1), vector G is a vector sum of component vector of three orthogonal axes at constant velocity or in still. From Equation (2), square root of square sum of component acceleration on three orthogonal axes is equal to 1g, if this accelerometer is at constant velocity or in still.

With zero g bias of each axis (X0, Y0, Z0) have been calculated in Equation (3), (4) and (5). Sensitivity associated with each axis of accelerometer can be calibrated by placing hexahedron jig on Platform with following sequence.
Measure voltage output on each axis of accelerometer with X axis points to ground (X axis at downward direction).
   x1, y1, z1.
Measure voltage output on each axis of accelerometer with Y axis points to ground (Y axis at downward direction).
   x2, y2, z2.
Measure voltage output on each axis of accelerometer with Z axis points to ground (Z axis at downward direction).
   x3, y3, z3.

Sensitivity associated with each axis is calculated by taking square root of square sum of gravity component for specific axis points to three orthogonal directions.

Sx=√((x1−X0)²+(x2−X0)²+(x3−X0)²) Equation (6)

Sy=√((y1−Y0)²+(y2−Y0)²+(y3−Y0)²) Equation (7)

Sz=√((z1−Z0)²+(z2−Z0)²+(z3−Z0)²) Equation (8)

Normally, zero g bias and 1g sensitivity on each axis of accelerometer calibrated at specific temperature will remain un-change at that temperature and are not necessarily re-calibrated. Unfortunately, both zero g bias and 1g sensitivity are temperature dependent. In other word, both parameters change as results of changing in environment temperature. This phenomenon is so called temperature drift. Moreover, direction and amplitude of temperature drift is non linear, no orientation and is not predictable either. The zero g bias and 1g sensitivity calibrated at specific temperature (room temperature 24° C. in normal) are only accurate at that specific temperature.

To assure that all MEMS accelerometer can work at any temperature ranging from −40° C. to 85° C. An algorithm of temperature compensation is going to be filed in a separated patent application later on.

### Algorithm for Calibrating 9 Direction Cosines:—(5)

In general, there is a slight alignment error between three orthogonal axes and package of an accelerometer. In mounting accelerometer on a circuit board and configuring the circuit board to a device. Error of misalignment is accumulated same as accumulated tolerance in machining. Sum of the all above errors will incur a total rotated angle between three orthogonal axes of accelerometer and body axes of the device or a desired (target) coordinate.

Coordinate transfer of acceleration on 3 axes of accelerometer to orthogonal axes of target coordinate is necessary if a very precise measurement of acceleration on each axis of device orthogonal axes (or desired coordinate) is required. As if a single axis accelerometer is attached on every axis of desired coordinate after coordinate transfer.

### Equations of Coordinate Transfer are:

Ax=a1X′+a2Y′+a3Z′ Equation (9)

Ay=b1X′+b2Y′+b3Z′ Equation (10)

Az=c1X′+c2Y′+c3Z′ Equation (11)

Ax, Ay, Az: Acceleration (to be calculated) on device orthogonal axes (X, Y, and Z axis).
X′, Y′, Z′: Acceleration sensed by three axes accelerometer.
a1, a2, a3, b1, b2, b3, c1, c2, c3: 9 direction cosines between three axes of accelerometer and three axes of target coordinate to be used as conversion parameters in calculating coordinate transfer.

How to find out 9 direction cosines between three axes of accelerometer and three axes of target coordinate is a big challenge for most users. Obviously, this is not an easy job in searching for direction cosine, if using an ordinary approach by measuring angle between two axes.

Present invention discloses a simple approach for calculating 9 direction cosines as parameters to be used in Equation (9), Equation (10) and Equation (11). In fact, outputs of 3 axes of accelerometer measured at three procedures during calibrating 1g sensitivity can be used as raw data for calculating 9 cosine factors. Data collected at above process are (x1, y1, z1), (x2, y2, z2) and (x3, y3, z3) respectively. The 9 direction cosines can be calculated by converting 9 voltage outputs collected at procedure of calibrating 1g sensitivity into g values.

The g value on specific accelerometer axis is compared with 1g (g value on the body axis pointed downward). Result of comparison (or ratio) is direction cosine of specific accelerometer axis versus body axis of target coordinate (pointed downward). Equations for calculating 9 direction cosines of three axes of accelerometer versus three axes of target coordinate are:

a1=((x1—X0)/Sx)/1g Equation (12)

Direction cosine between X′ axis of Accelerometer and X axis of target coordinate.

a2=((y1−Y0)/Sy)/1g Equation (13)

Direction cosine between Y′ axis of Accelerometer and X axis of target coordinate.

a3=((z1−Z0)/Sz)1g Equation (14)

Direction cosine between Z′ axis of Accelerometer and X axis of target coordinate.

a4=((x2−X0)/Sx)/1g Equation (15)

Direction cosine between X′ axis of Accelerometer and Y axis of target coordinate.

a5=((y2−Y0)/Sy)/1g Equation (16)

Direction cosine between Y′ axis of Accelerometer and Y axis of target coordinate.

a6=((z2−Z0)/Sz)/1g Equation (17)

Direction cosine between Z′ axis of Accelerometer and Y axis of target coordinate.

a7=((x3−X0)Sx)/1g Equation (18)

Direction cosine between Z′ axis of Accelerometer and Z axis of target coordinate.

a8=((y3−Y0)/Sy)/1g Equation (19)

Direction cosine between Z′ axis of Accelerometer and Z axis of target coordinate.

a9=((z3−Z0)/Sz)/1g Equation (20)

Direction cosine between Z′ axis of Accelerometer and Z axis of target coordinate.

### BRIEF DESCRIPTION OF THE DRAWINGS

FIG. 1 is a block diagram that illustrates the calibration system for an accelerometer in accordance with an embodiment of the present invention.

FIG. 2 is a flowchart that illustrates the calibration method for an accelerometer in accordance with an embodiment of the present invention.

FIG. 3 is a view of an application in accordance with an embodiment of the present invention.

### DESCRIPTION OF THE PREFERRED EMBODIMENT

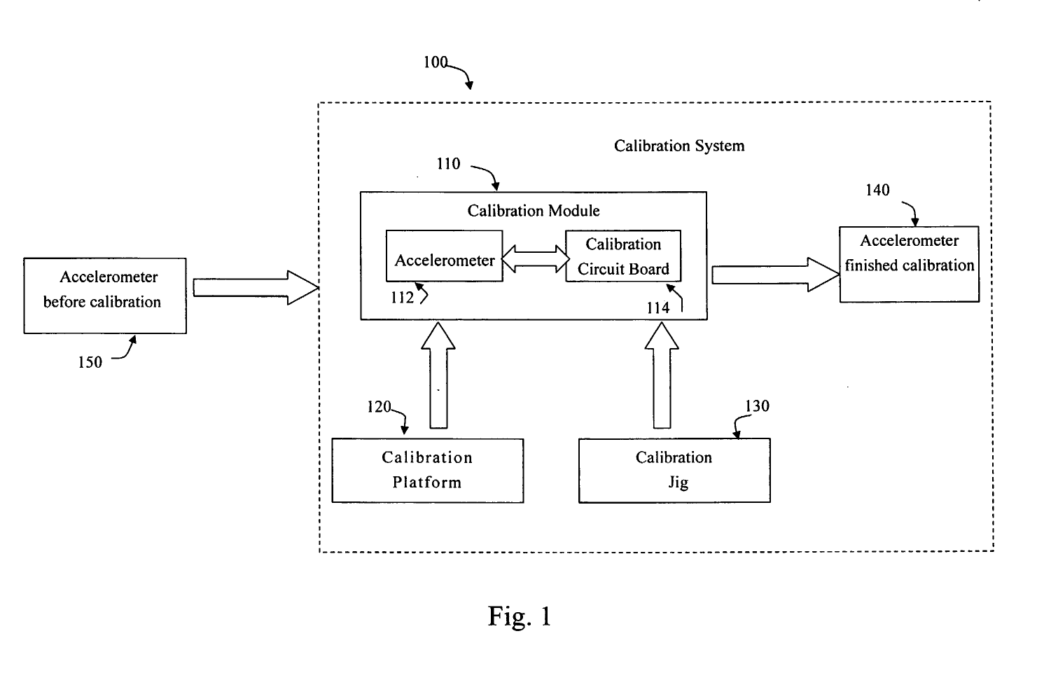

FIG. 1 is a block diagram that illustrates the calibration system for an accelerometer in accordance with an embodiment of the present invention. A Calibration System 100 comprises a calibration module 110, a calibration platform 120, a calibration jig 130, an accelerometer before calibration 150 and an accelerometer finished calibration 140.

Accelerometer before calibration 150 is placed on Calibration Module 110 which is embedded inside the Calibration Jig 130. The Calibration Module 110 includes a single/dual/three axes accelerometer 112, a Calibration Circuit Board 114 and necessary hardware, software, data storage/display. An accelerometer 112 (was Accelerometer 150 originally) is calibrated in calibration module 110 with algorithms of the present invention in Calibration System 100. As well known, the Calibration Module 110 also includes a CPU, a memory, a display unit, I/O unit and so on, but detail structures, materials functions are not shown here to prevent reader from obscuring aspects of the invention.

Calibration Jig 130 is a hexahedron jig having at least four planes arranged in parallel and vertical configuration with each other to be a reference of horizontal or vertical calibration when the Calibration Module 110 calibrates the Accelerometer 112. The Calibration Platform 120 is approved by a leveling instrument to prevent error due to tilting ground during calibrating.

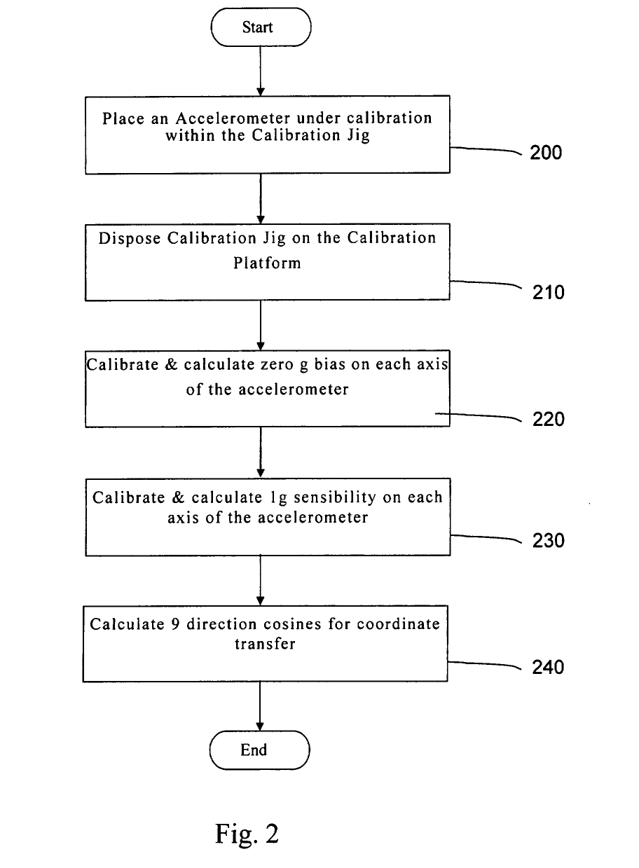

FIG. 2 is a flowchart that illustrates the calibration method for an accelerometer in accordance with an embodiment of the present invention.

Step 200→An accelerometer 150 is placed inside Calibration Jig 130.

Step 210→Calibration Jig 130 is disposed on Calibration Platform 120 with Z axis of Calibration Jig pointed upward. Outputs of each axis (x_, y_, z_) of accelerometer are measured by Calibration Circuit Board 114, before be transferred to Calibration Module 110 and stored in memory for calculating zero g bias in next step (Step 220).

Step 220→(Calibrate zero g bias): Calibration Jig 130 is disposed on Calibration Platform 120 with Z axis of Calibration Jig pointed downward. Outputs of each axis (x, y, z) of accelerometer are measured by Calibration Circuit Board 114, before be transferred to Calibration Module and stored in memory. Zero g bias of each axis (X0, Y0, Z0) on accelerometer is calculated by taking average (Equation (3), Equation (4) and Equation (5)) between two measurements.

Step 230→(Calibrate 1g sensitivity): Calibration Jig 130 is disposed on Calibration Platform 120 with X axis of Calibration Jig pointed downward. Outputs of each axis (x1, y1, z1) of accelerometer are measured by Calibration Circuit Board 114, then are transferred to Calibration Module110 and stored in memory.

Calibration Jig 130 is disposed on Calibration Platform 120 again with Y axis of Calibration Jig pointed downward. Outputs of each axis (x2, y2, z2) of accelerometer are measured by Calibration Circuit Board 114, then are transferred to Calibration Module and stored in memory.

Calibration Jig 130 is disposed on Calibration Platform 120 again with Z axis of Calibration Jig pointed downward. Outputs of each axis (x3, y3, z3) of accelerometer are measured by Calibration Circuit Board 114, then are transferred to Calibration Module and stored in memory. Note: This procedure can be eliminated if Step 220 of calibrating zero 0g was done previously. Data (x3, y3, z3) to be collected at this process can be replaced by (x, y, z) collected in Step 220.

Sensitivity of each axis (Sx, Sy, Sz) on accelerometer are calculated from Equation (6), Equation (7) and Equation (8). Sensitivities associated each axis are stored in flash memory as parameters to be used in run mode.

Step 240→(Calibrate 9 direction cosines): Calibration Jig 130 is disposed on Calibration Platform 120 with X axis, Y axis and Z axis of Calibration Jig pointed downward in sequence same as Step 230 (Calibrate 1g sensitivity). Outputs of each axis (x1, y1, z1), (x2, y2, z2), (x3, y3, z3) of accelerometer are measured by Calibration Circuit Board in sequence, transferred to Calibration Module and stored in memory. However, Outputs of each axis (x1, y1, z1), (x2, y2, z2), (x3, y3, z3) of accelerometer collected at Step 230 (Calibrate 1g sensitivity) can be used for Calculating 9 direction cosines without performing the same measuring procedures as defined at Step 230.

Direction cosine of any axis of accelerometer versus body axis of device (or target coordinate) is calculated from Equation (12) to Equation (20). Total 9 direction cosines are converting parameters to be used for coordinate transfer.

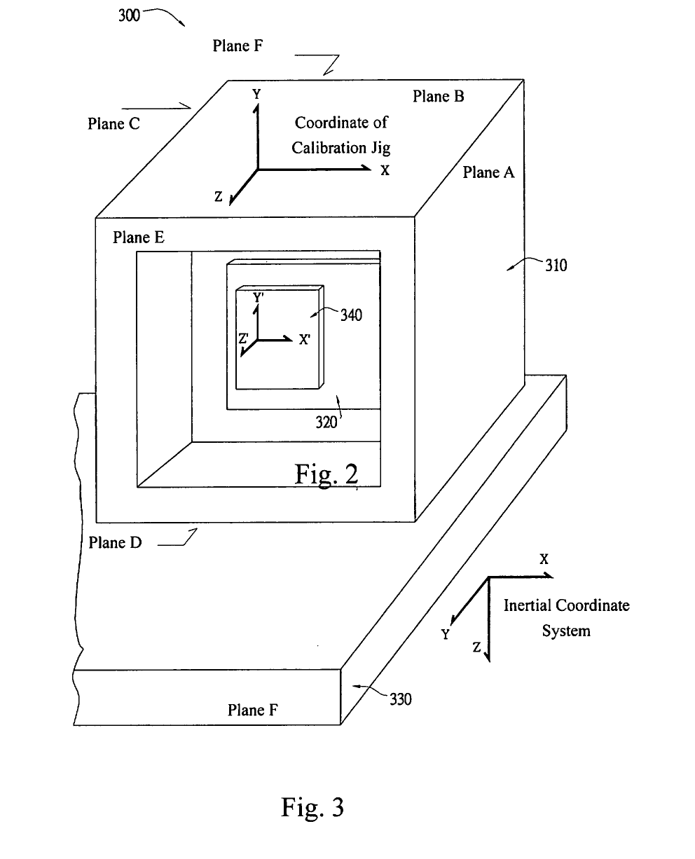

FIG. 3 shows a Calibration System 300 to calibrate an accelerometer in accordance with an embodiment of the present invention. A Calibration Jig 310 is a hollow hexahedron jig (a Calibration Module 320 disposed therein) for a reference of horizontal (zero g) or vertical (1g) calibration while an Accelerometer 340 is under calibrated. The hexahedron structure includes at least four planes of which surfaces are smooth arranged in parallel and vertical configuration with each other. Calibration Jig 310 is placed on Calibration Platform 330 (Leveled already) in sequence during calibration procedure.

### Experiment and Data Collected

The Calibration Module 320 contains an Accelerometer 340 to be calibrated. Calibration Module is disposed within the Calibration Jig 310 which is a hollow hexahedron jig. Calibration Module 320 includes an evaluation board of tested accelerometer (for example ADXL 330-EB) and other necessary devices for operating and processing. In an embodiment, the test board may be a product produced by Analog Device Inc., but it is not limited to the present invention. MCU, memory for computing or memorizing may be not necessary at this experiment except a three axes accelerometer (for example ADXL 330, not shown) formed thereon applied to operate with other components. Power supply of the test board is provided by an external 3V voltage regulator (not shown) because the output mode of the test board is in the ratio of supply voltage. Output terminals of three axes of the accelerometer are connected to Calibration Jig 310 through three wires and are measured by a digital meter (for example Fluke 189, with 0.1 mV resolution and is not shown here) outside Calibration Jig 310.

### Back to Flow Chart at FIG. 2:

Step 200→Place an Accelerometer EV board with P/N: ADXL 33EB to be calibrated within Calibration Jig.
Step 210→Dispose Calibration Jig on the Calibration Platform with Y axis of hexahedron jig is pointed upward (Plane B up in FIG. 3). Outputs of three axis of accelerometer are:

x=1,504.4 mV; y=1,230.5 mV; z=1,383.4 mV
Step 220→Dispose Calibration Jig on the Calibration Platform with Y axis of hexahedron jig is pointed downward (Plane D up in FIG. 3). Outputs from three axis of accelerometer are:

x_{—}=1,518.3 mV; y_{—}=1,819.0 mV; z_{—}=1,375.0 mV.
Calculate zero g bias of each axis from Equation (3),(4),(5)

X0=(x_{—}+x)/2=1,511.3 mV

Y0=(y_{—}+y)/2=1,524.7 mV

Z0=(z_{—}+x)/2=1,379.2 mV
Step 230 →Dispose Calibration Jig on the Calibration Platform with X, Y, Z axis of hexahedron jig pointed ground in sequence.
   Three set outputs from each axis of accelerometer are:

x₁=1,801.8 mV; y₁=1,517.6 mV, z₁=1,367.8 mV;

x₂=1,518.3 mV; y₂=1,819.0 mV; z₂=1,375.0 mV;

x₃=1,504.6 mV; y₃=1,521.4 mV z₃=1,060.6 mV;
Sensitivity of each axis is calculated from Equation 6, 7, 8,

Sₓ=√((x₁−X0)²+(x₂−X0)²+(x₃−X0)²)=290.7 mV

S_{y}=√((y₁−Y0)²+(y₂−Y0)²+(y₃−Y0)²)=294.4 mV

S_{z}=√((z₁−Z0)²+(z₂−Z0)²+(z₃−Z0)²)=318.8 mV
Step 240→Apply data collected from Step 230 into Equation 9, 10, 11 for calculating 9 direction cosines. It is not necessary to measure 3 set outputs from accelerometer again.

a1=(x₁−X′₀)/Sₓ/g=0.9993120

a2=(y₁−Y′₀)/S_{y}/g=−0.024117

a3=(z₁−Z′₀)/S_{z}/g=−0.035759

b1=(x₂−X′₀)/Sₓ/g=0.023048

b2=(y₂−Y′₀)/S_{y}/g=0.999660

b3=(z₂−Z′₀)/S_{z}/g=−0.013174

c1=(x₃−X′₀)/Sₓ/g=−0.023048

c2=(y₃−Y′₀)/S_{y}/g =−0.011228

c3=(z₃−Z′₀)/S_{z}/g=−0.999373

### Proven by Running an Experiment

In Run mode, Calibration Jig 310 is used as a housing of Inclinometer. Inclinometer (Same as Calibration Jig 310) is placed with plane E downwardly (Z axis pointed down) on a surface in which a tilt angle along X axis is to be measured (tilted angle is 30 degree in this case). Zero g bias and 1g sensitivity associated with each axis of Accelerometer inside Inclinometer and 9 direction cosines have been calibrated and calculated in calibration mode. Those parameters are:

Zero g bias on three axes of Accelerometer:

X′0=1,511.3 mV, Y′0=1,524.7 mV, Z′0=1,379.2 mV

1g sensitivity on three axes of Accelerometer:

Sₓ=290.7 mV, S_{y}=294.4 mV, S_{z}=318.8 mV

9 direction cosines are calculated in calibration mode.

a1=0.999312 a2=−0.024117; a3=−0.035759;

b1=0.023048; b2=0.999660 b3=−0.013174;

c1=−0.023048; c2=−0.011209 c3=−0.999373;

Tilted angle along X axis is measured and calculated as following:

1. Measure Outputs Voltages on X′, Y′, Z′ axes of Accelerometer:

x′=1,359.6 mV

y′=1,274.0 mV

z′=1,383.0 mV

2. Convert Voltage Outputs to g Values on Accelerometer axes:

Voltage outputs on X′, Y′, Z′ axes of accelerometer are converted to g values by subtracting 0g associated with each axis from output, then divided by 1g sensitivity associated with each axis.

$$\begin{matrix}{x}_{g}^{′} = ( {x}^{′} - {X}_{0}^{′} ) / {Sx}^{′} \\ = ( 1 , 359.6 mV - 1 , 511.3 mV ) / 290.7 mV \\ = - 0.52184 g\end{matrix}$$

$$\begin{matrix}{y}_{g}^{′} = ( {y}^{′} - {Y}_{0}^{′} ) / {Sy}^{′} \\ = ( 1 , 2470 mV - 1 , 524.7 mV ) / 294.4 mV \\ = - 0.85156 g\end{matrix}$$

$$\begin{matrix}{z}_{g}^{′} = ( {z}^{′} - {Z}_{0}^{′} ) / {Sz}^{′} \\ = ( 1 , 3830 mV - 1 , 379.2 mV ) / 318.18 mV \\ = 0.01192 g\end{matrix}$$

3. Transfer g Values on each Axis of Accelerometer onto Body Axis of Inclinometer:

Acceleration with g-value on each axis (x′_{g}, y′_{g}, z′_{g}) of Accelerometer are transferred to body axes (X_{g}, Y_{g}, Z_{g}) of Inclinometer through coordinate transfer. As if each body axis of inclinometer has a G sensor attached on. Formula of coordinate transfer is shown below.

[X_{g}][a1a2a3][x′_{g}] [−0.52184]

[Y_{g}]=[b1b2b3]*[y′_{g}]=[−0.85156]

[Z_{g}][c1c2c3][z′_{g}][0.01192]

### Note:

[X_{g}] [Y_{g}] [Z_{g}]=−0.50137, [−0.86345], [0.00966] are calculated g− values on body axes of Inclinometer.
[x′_{g}] [y′_{g}] [z′_{g}] are g-values sensed by three axes of Accelerometer.
[a1 a2 a3] [b1b2 b3] [c1 c2 c3] are 9 direction cosines calculated in calibration mode.

a1=0.999312; a2=−0.024117; a3=−0.035759

b1=0.023048 b2=0.999660; b3=−0.013174

c1=−0.023058; c2=−0.011209; c3=−0.999373

### 4. Calculate Tilted Angle Along X Axis on a Surface:

Finally, the tilted angle along X axis is calculated with g-values on three body axes of Inclinometer as parameters.

$$\begin{matrix}{θ}_{x} = {tan}^{- 1} ( {X}_{g} / √ ( {Y}_{g} + {Z}_{g}^{2} ) ) \\ = {tan}^{- 1} ( - 0.50137 / √ ( {( - 0.86345 )}^{2} + {0.00966}^{2} ) \\ = {tan}^{- 1} ( - 0.50137 g / 0.86350 g ) \\ = - 30.14 degree\end{matrix}$$

There is an alternative way to calculate tilted angle along X axis with less accuracy by using g-value on X axis.

$$\begin{matrix}{θ}_{x} = {sin}^{- 1} ( {X}_{g} / g ) \\ = {sin}^{- 1} ( - 0.50137 g \text{/} 1 g ) \\ = - 30.09 degree\end{matrix}$$

As is understood by a person skilled in the art, the foregoing preferred embodiments of the present invention are illustrated of the present invention rather than limiting of the present invention. It is intended to cover various modifications and similar arrangements included within the spirit and scope of the appended claims, the scope of which should be accorded the broadest interpretation so as to encompass all such modifications and similar structure. While the preferred embodiment of the invention has been illustrated and described, it will be appreciated that various changes can be made therein without departing from the spirit and scope of the invention.

We claim:

1. A calibration system for an accelerometer, comprising:
a calibration jig; and
a calibration module to perform three algorithms for calibrating an accelerometer and calculating parameters for coordinate transfer.

2. The system of claim 1, wherein said calibration jig comprises a hexahedron jig having a plurality of six planes arranged in parallel or vertical with each other for providing a reference when calibrating said accelerometer.

3. The system of claim 1, wherein the first of said three algorithms is for calibrating zero g bias on each axis of said accelerometer.

4. The system of claim 1, wherein the second of said three algorithms is for calibrating 1g sensitivity on each axis of said accelerometer.

5. The system of claim 1, wherein the third of said three algorithms is for calibrating and calculating nine direction cosines of said parameters to be used in coordinate transfer.

6. The system of claim 1, wherein said calibration module includes a calibration circuit.
